(19) United States
(12) Patent Application Publication
(10) Pub. No.: US 2014/0250389 A1
(43) Pub. Date: Sep. 4, 2014

(54) METHOD AND DEVICE FOR SELECTING FRIENDS IN MICROBLOGGING

(71) Applicant: TENCENT TECHNOLOGY (SHENZHEN) COMPANY LIMITED, Shenzhen City (CN)

(72) Inventors: CHEN ZHANG, Shenzhen City (CN); JING ZHANG, Shenzhen City (CN); YANG LI, Shenzhen City (CN); MEINA LI, Shenzhen City (CN); DANZHI CHEN, Shenzhen City (CN); QUNLI MA, Shenzhen City (CN); NIAN LIU, Shenzhen City (CN); YUFEI LIU, Shenzhen City (CN); JUN YE, Shenzhen City (CN)

(73) Assignee: TENCENT TECHNOLOGY (SHENZHEN) COMPANY LIMITED, Shenzhen City (CN)

(21) Appl. No.: 14/274,672

(22) Filed: May 9, 2014

Related U.S. Application Data
(63) Continuation of application No. PCT/CN2012/081686, filed on Sep. 20, 2012.

(30) Foreign Application Priority Data
Nov. 9, 2011 (CN) 201110352052.1

(51) Int. Cl. G06F 3/0482; G06F 3/0484

(52) U.S. Cl. CPC G06F 3/0482; G06F 3/04842
USPC 715/753

(57) ABSTRACT

Method and device for selecting friends in microblogging are disclosed. The method includes steps of: the method comprising steps of: calling a friend-select interface and displaying a friend list, a friend address bar and a friend-confirm button on the friend-select interface in response to a detection of an event of a friend-select trigger button being clicked by a user account; adding friend identifiers corresponding to N friends into the friend address bar in response to a detection of an event of the N friends in the friend list being selected by the user account; and detecting an even of the friend-confirm button being clicked by the user account and thereby realizing a selection of the N friends in microblogging, wherein N is an integer greater than 1. Thus, the present invention provides an improved user experience when users try to perform a multi friend selection in microblogging.

### CROSS-REFERENCE TO RELATED APPLICATION

This application is a continuation application of International (PCT) Patent Application No. PCT/CN2012/081686 filed on Sep. 20, 2012, now pending and designating the United States, which also claims benefit of China Patent Application No. 201110352052.1, filed on Nov. 9, 2011. The entirety of the above-mentioned patent applications is hereby incorporated by reference herein and made a part of this specification.

### FIELD OF THE INVENTION

The present invention relates to the computer field, and more particularly to method and device for selecting friends in a microblogging.

### BACKGROUND OF THE INVENTION

With the widespread use of touch screen mobile phone, users are getting widespread concern over the touch-screen-mobile-phone-based microblogging.

To share information with a specified friend, a user account needs to select a specified friend by using “@ friend's name” in a microblogging write operation before sending the information to the selected friend; wherein “@” herein means “share information with”. In other words, if the user account would like to share information with one specified friend, he/she needs to click on the @ button first and then selects this friend's name from a friend list. Based on the same manner, if the user account tries to share information with N friends, the user account needs to click on the @ button N times for the selection of the N friends due to only one friend can be selected from the friend list by one click of the @ button; wherein N is a positive integer and greater than 1. Thus, the complicate process for selecting N friends may lead to a poor user experience when a user account tries to share information with N friends in microblogging.

### SUMMARY OF THE INVENTION

To provide an improved user experience when a user account tries to select multi friends for an information sharing in microblogging, the present invention provides method and device for selecting friends in microblogging.

The present invention provides a method for selecting friends in a microblogging. The method includes steps of: calling a friend-select interface and displaying a friend list, a friend address bar and a friend-confirm button on the friend-select interface in response to a detection of an event of a friend-select trigger button being clicked by a user account; adding friend identifiers corresponding to N friends into the friend address bar in response to a detection of an event of the N friends in the friend list being selected by the user account; and detecting an even of the friend-confirm button being clicked by the user account and thereby realizing a selection of the N friends in the microblogging, wherein N is an integer and greater than 1.

The present invention further provides a device for selecting friends in a microblogging. The device includes a call-and-display module, an adding module and a detecting module. The call-and-display module is configured to call a friend-select interface and display a friend list, a friend address bar and a friend-confirm button on the friend-select interface in response to a detection of an event of a friend-select trigger button being clicked by a user account. The adding module is configured to add friend identifiers corresponding to N friends into the friend address bar in response to a detection of an event of the N friends in the friend list being selected by the user account. The detecting module is configured to detect an even of the friend-confirm button being clicked by the user account and thereby realizing a selection of the N friends in the microblogging, wherein N is an integer and greater than 1.

In summary, when trying to select N friends for an information sharing in microblogging, a user account only needs to click the friend-select trigger button one time and thereby being able to select the N friends from the friend list displayed on the friend-select interface called by the friend-select trigger button. Consequentially, the selection of the N friends in microblogging is realized when a related mobile device detects an even of the friend-confirm button being clicked by the user account. Thus, compared with the prior art requiring to click the friend-select trigger button N times for the selection of the N friends, the present invention provides an improved user experience when users try to perform a multi friend selection in microblogging.

### BRIEF DESCRIPTION OF THE DRAWINGS

In order to describe the embodiments of the present invention more clearly, the accompanying drawings required for describing the embodiments are briefly introduced hereinafter. It is apparent that the accompanying drawings are only used for illustrating some of the embodiments of the present invention, and for those ordinarily skilled in the art, further drawings can be realized without additional inventive efforts:

FIG. 1 is a flowchart schematically illustrating a method for selecting friends in microblogging in accordance with the first embodiment of the present invention;

FIG. 2 is a flowchart schematically illustrating a method for selecting friends in microblogging in accordance with the second embodiment of the present invention;

FIG. 3 is a view schematically illustrating an @ button is being clicked;

FIG. 4 is a schematic view of a friend-select interface;

FIG. 5 is a view schematically illustrating an OK button is being clicked after the N friends are selected;

FIG. 6 is a view schematically illustrating the left-hiding operation is performed on the text in the friend address bar; and

FIG. 7 is a structural view of a device for selecting friends in microblogging in accordance with the third embodiment of the present invention.

### DETAILED DESCRIPTION OF PREFERRED EMBODIMENTS

Hereinafter, combined with the accompanying drawings of the embodiments of the present invention, the technical solutions of the embodiments of the present invention are clearly and fully described. It is apparent that the embodiments are only some of the embodiments of the present invention other than all the embodiments. Based on the embodiments of the present invention, all the other embodiments derived therefrom without additional inventive efforts of an ordinarily skilled person in the art are included in the scope of the present invention.

The present invention discloses method and device for selecting friends in microblogging.

### First Embodiment

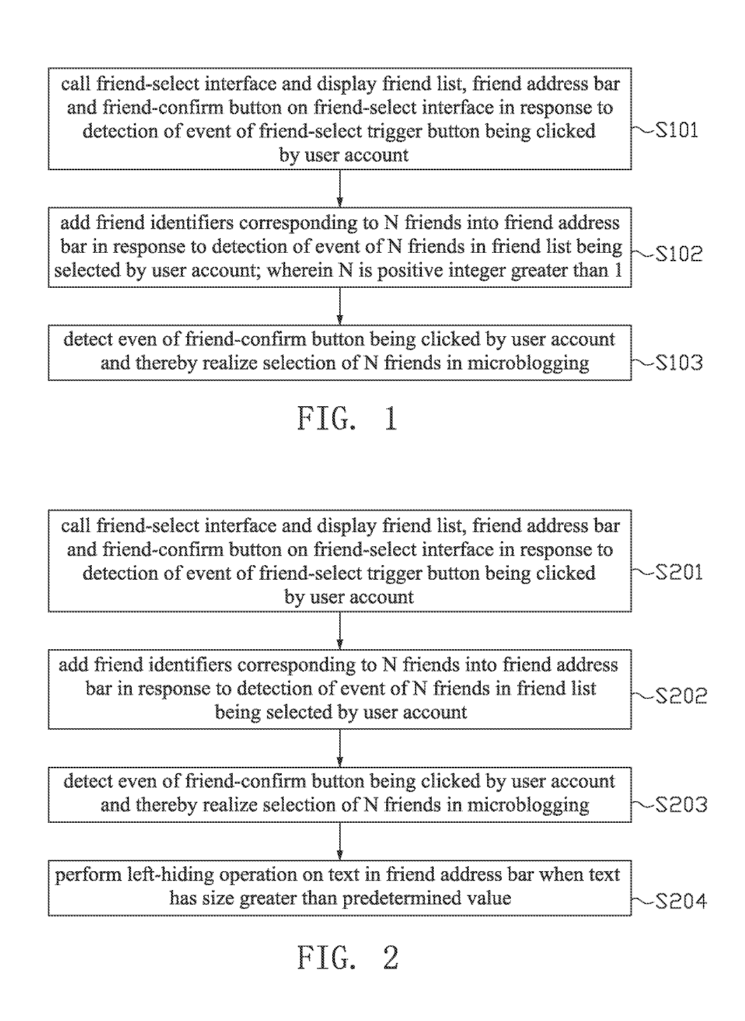

FIG. 1 is a flowchart schematically illustrating a method for selecting friends in microblogging in accordance with the first embodiment of the present invention. As shown, the method in this embodiment includes steps S101˜S103.

Step S101: calling a friend-select interface and displaying a friend list, a friend address bar and a friend-confirm button on the friend-select interface in response to a detection of an event of a friend-select trigger button being clicked by a user account.

Step S102: adding the friend identifiers corresponding to N friends into the friend address bar in response to a detection of an event of the N friends in the friend list being selected by the user account; wherein N is a positive integer and greater than 1.

Step S103: detecting an even of the friend-confirm button being clicked by the user account and thereby realizing a selection of the N friends in the microblogging.

In one embodiment, the step S102 of adding the friend identifiers corresponding to N friends into the friend address bar in response to a detection of an event of the N friends in the friend list being selected by the user account may be realized by: adding the friend identifiers corresponding to the N friends into the friend address bar in response to a detection of an event of friend-select icons corresponding to the N friends in the friend list being checked by the user account.

In another embodiment, the step S102 of adding the friend identifiers corresponding to N friends into the friend address bar in response to a detection of an event of the N friends in the friend list being selected by the user account may be realized by: adding the N friend identifiers or the friend identifiers corresponding to N friend images into the friend address bar in response to a detection of an event of the friend identifiers or the friend images corresponding to the N friends in the friend list being clicked by the user account.

In addition, the method for selecting friends in a microblogging in this embodiment may further include a step of: performing a left-hiding operation on the text in the friend address bar when the text has a size greater than a predetermined value. The left-hidden operation herein means that the most left text (or, the friend identifier(s)) in the friend address bar is hidden when a relatively large number of friends in the friend list is selected and not all of the corresponding friend identifiers are able to be displayed in the friend address bar.

In one embodiment, the friend identifier may include a nickname of the respective friend.

In this embodiment, the friends-select trigger button may refer to an @ button in an actual microblogging operation interface; the friend address bar may refer to an @ box in an actual microblogging operation interface and is used for displaying one or more friend identifiers; and the friend-confirm button may refer to an “OK” button in an actual microblogging operation interface.

In summary, when trying to select N friends for an information sharing in microblogging, a user account only needs to click the friend-select trigger button one time and thereby being able to select the N friends from the friend list displayed on the friend-select interface called by the friend-select trigger button. Consequentially, the selection of the N friends in microblogging is realized when a related mobile device detects an even of the friend-confirm button being clicked by the user account. Thus, compared with the prior art requiring to click the friend-select trigger button N times for the selection of the N friends, the present embodiment provides an improved user experience when users try to perform a multi friend selection in microblogging.

### Second Embodiment

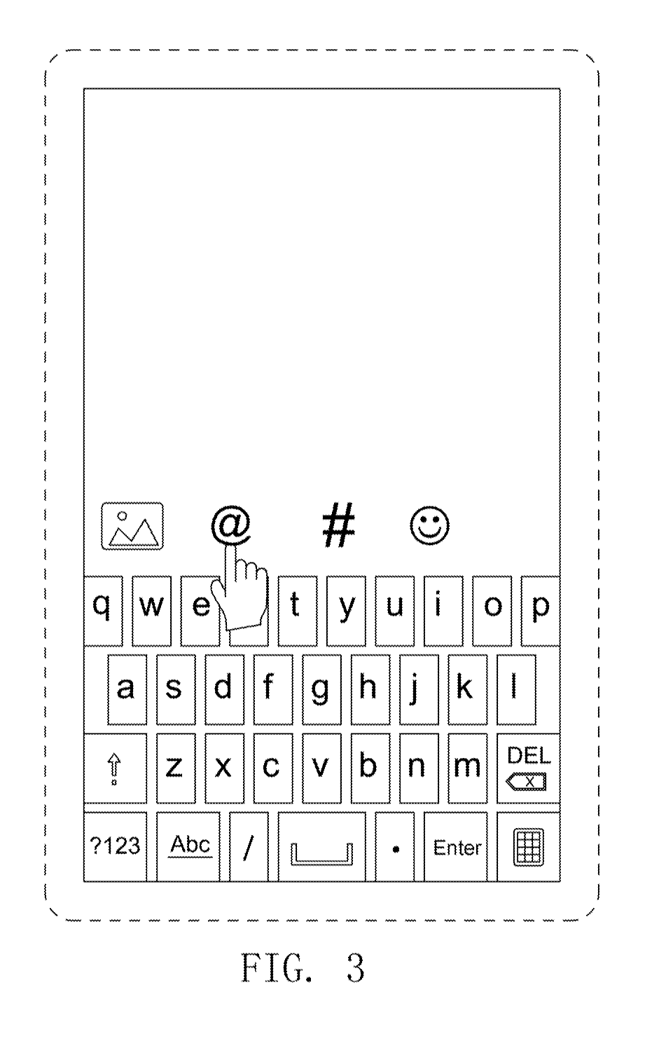

FIG. 2 is a flowchart schematically illustrating a method for selecting friends in microblogging in accordance with the second embodiment of the present invention; wherein the main implementation of the present embodiment may be a mobile device, in particular, a mobile phone, but the present invention is not limited thereto. As shown, the method for selecting friends in microblogging in this embodiment includes steps S201˜S204.

Step S201: calling a friend-select interface and displaying a friend list, a friend address bar and a friend-confirm button on the friend-select interface in response to a detection of an event of a friend-select trigger button being clicked by a user account

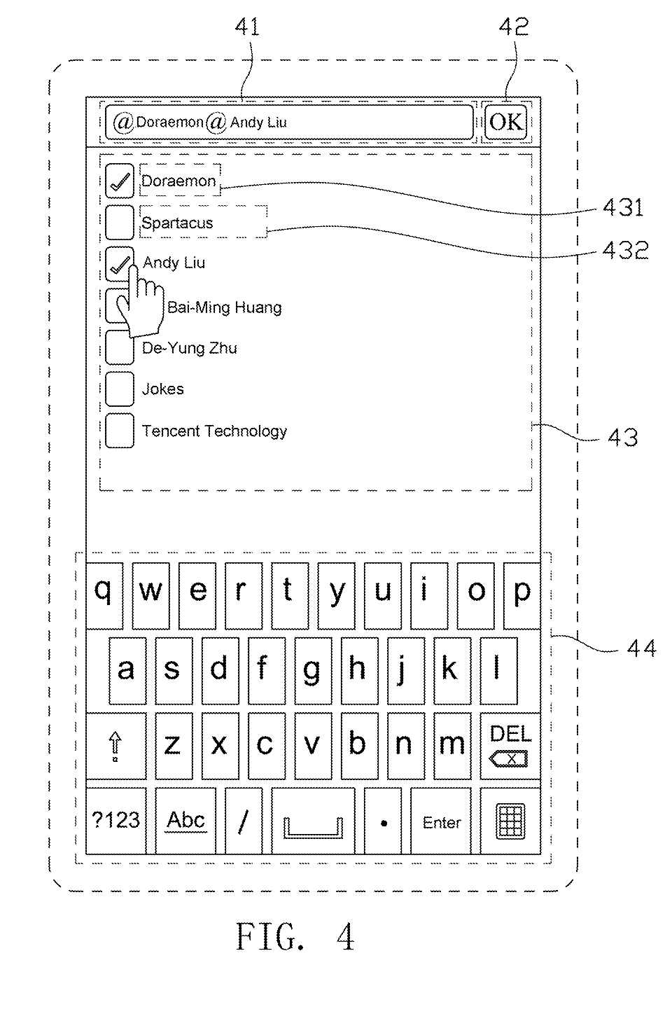

In mobile-phone microblogging, a user account needs to click on the friend-select trigger button for performing a multi friend selection if trying to share information with more than one friends; wherein the friend-select trigger button may be an @ button. Specifically, in a microblogging edit mode, if the user account tries to share information with N friends, the user account first needs to click on the @ button displayed on a microblogging write operation interface, as illustrated in FIG. 3; wherein the @ button is the aforementioned friend-select trigger button. Then, the friend-select interface including the friend list, friend address bar and friend-confirm button is called by the mobile phone, as illustrated in FIG. 4; wherein N is a positive integer greater than 1.

FIG. 4 is a schematic view of a friend-select interface. As shown, the friend-select interface includes an @ box 41, an “OK” button 42, a friend list 43 and a virtual-keyboard area 44. The @ box 41 herein is referred to as a friend address bar and the “OK” button 42 herein is referred to as a friend-confirm button. Specifically, the @ box 41 is used for displaying the friend identifiers corresponding to the friends selected by a user account. The friend list 43 includes the friend of the user account and from which the user account can select one or more friends for an information sharing. The “OK” button 42 is placed on the right of the @ box 41; wherein the N friend selection in microblogging is complete when the user account clicks on the “OK” button 42.

In one embodiment, the friend list includes friend identifiers, wherein each one of the friend identifier may include a nickname of a respective friend. For example, as shown in FIG. 4, the nickname 431 is the nickname of the first friend in the friend list 43 and the nickname 432 is the nickname of the second friend. The friend identifiers in FIG. 4 are exemplified by friend nicknames; however, it is understood that the friend identifiers may include any specific identifiers capable of being distinguished and identified, and the present invention is not limited thereto.

Preferably, the friend list 43 may further include friend check icons corresponding to the friend identifiers in one-to-one manner. In one embodiment, each one of the friend check icons may be placed on the left side of the respective friend identifier, as illustrated in FIG. 4; in another embodiment, each one of the friend check icons may be placed on the right side of the respective friend identifier; and the present invention is not limited thereto. By checking the friend check icon(s), the user account is aware of which corresponding friend identifier(s) is selected so as to prevent a re-selection from occurring.

Preferably, the friend list 43 may further include friend images (not shown) corresponding to the friend identifiers in one-to-one manner; wherein the relative position between the friend image and the respective friend identifier is not limited in the present embodiment. In addition, it is understood that the friend list 43 may include the friend identifiers, the friend check icons and the friend images all; wherein the relative position among the friend identifier, the respective friend image and the respective friend identifier is not limited in the present embodiment.

Step S202: adding the friend identifiers corresponding to the N friends into the friend address bar in response to a detection of an event of the N friends in the friend list being selected by the user account.

In the embodiment of the friend list including the friend identifiers only, the selection of the N friends is realized by the user account clicking on the corresponding N friend identifiers in the friend list. Specifically, the N friend identifiers are added into the friend address bar when the friend identifiers corresponding to the N friends in the friend list are selected by the user account.

In the embodiment of the friend list including the friend identifiers and the friend check icons, the selection of the N friends is realized by the user account checking the friend check icons corresponding to the friend identifiers in the friend list. Specifically, the N friends are in selected status and the friend identifiers corresponding to the N friends are added into the friend address bar when the friend check icons corresponding to the N friends in the friend list are checked by the user account.

In the embodiment of the friend list including the friend identifiers and the friend images, the selection of the N friends is realized by the user account clicking on the corresponding friend identifiers or the friend images in the friend list. Specifically, the N friend identifiers are added into the friend address bar when the friend identifiers or friend images corresponding to the N friends in the friend list are selected by the user account.

Step S202: detecting an operation of the user account clicking on the friend-confirm button and thereby realizing the selection of N friends in microblogging.

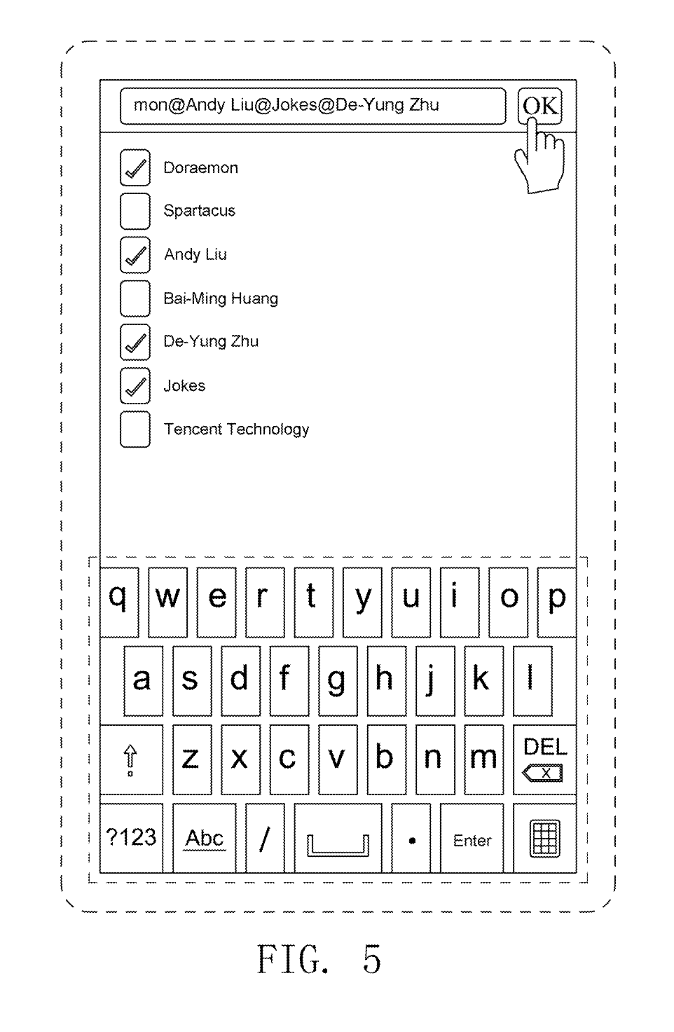

Specifically, as illustrated in FIG. 5, the selection of N friends in microblogging is complete once the user account clicks on the “OK” button after the N friend identifier are selected and confirmed by the user account; wherein the friend list in FIG. 5 is exemplified by including the friend identifiers and friend check icons.

In addition, the mobile phone obtains the N friend identifiers from the @ box in the friend-selection interface in response to a detection of the user account clicking on the “OK” button, and thereby realizing a selection of N friends in microblogging.

In the present embodiment, it is to be noted that the process of the mobile phone obtaining the N friend identifiers is complete only when the “OK” button is clicked by the user account. In addition, the mobile phone is quitted from a microblogging edit mode, the N friend identifiers are saved and the friend list is hidden when the user account clicks on the “OK” button.

Step S204: performing a left-hiding operation on the text in the friend address bar when the text therein has a size greater than a predetermined value.

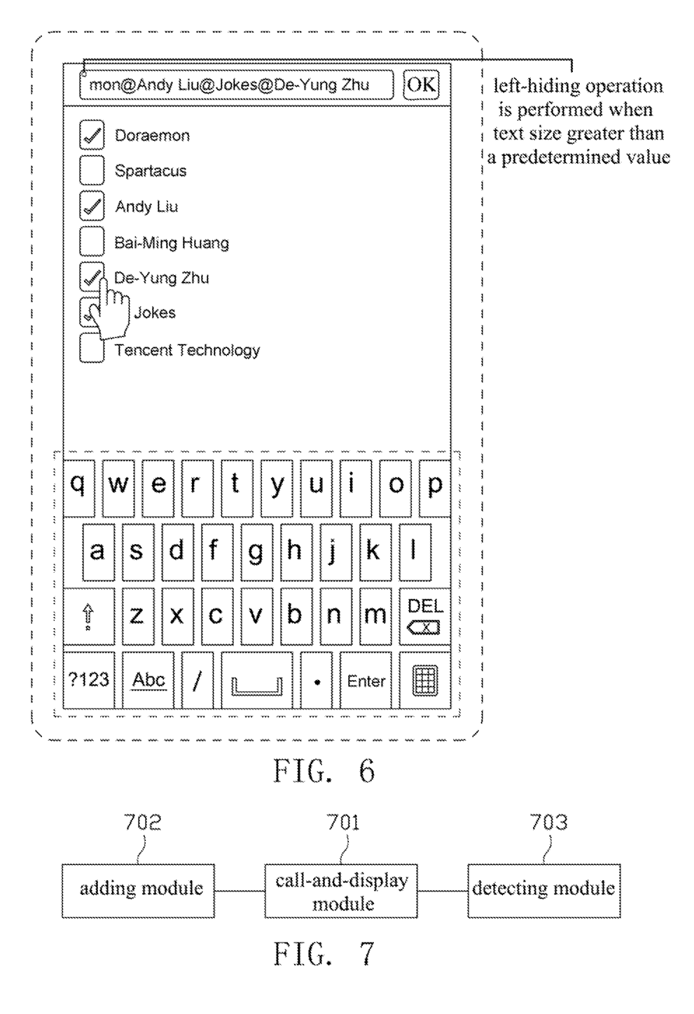

Specifically, if a relatively large number of friend identifiers in the friend list are selected, the text of the selected friend identifiers in the friend address bar may have a size greater than the predetermined value and accordingly the text of the latest selected friend identifiers may not be able to be added into the friend address bar. Thus, a left-hiding operation is performed on the text in the friend address bar (that is, the most left selected friend identifiers in the friend address bar are hidden) so as to make the latest selected friend identifiers visible in the friend address bar. For example, as illustrated in FIG. 6, the most left text is hidden.

In summary, when trying to select N friends for an information sharing in microblogging, a user account only needs to click the friend-select trigger button one time and thereby being able to select the N friends from the friend list displayed on the friend-select interface called by the friend-select trigger button. Consequentially, the selection of the N friends in microblogging is realized when a related mobile device detects an even of the friend-confirm button being clicked by the user account. Thus, compared with the prior art requiring to click the friend-select trigger button N times for the selection of the N friends, the present embodiment provides an improved user experience when users try to perform a multi friend selection in microblogging

### Third Embodiment

FIG. 7 is a structural view of a device for selecting friends in microblogging in accordance with the third embodiment of the present invention. The device in this embodiment may be a mobile device such as a mobile phone, but the present invention is not limited thereto.

As shown in FIG. 7, the device for selecting friends in microblogging in this embodiment includes a call-and-display module 701, an adding module 702 and a detecting module 703.

The call-and-display module 701 is configured to call a friend-select interface and display a friend list, a friend address bar and a friend-confirm button on the friend-select interface in response to a detection of an event of a friend-select trigger button on the device being clicked by a user account.

The adding module 702 is configured to add friend identifiers corresponding to N friends into the friend address bar in response to a detection of an event of the N friends in the friend list being selected by the user account; wherein N is a positive integer and greater than 1.

The detecting module 703 is configured to detect an even of the friend-confirm button being clicked by the user account and thereby realizing a selection of the N friends in microblogging.

In one embodiment, the adding module 702 may include a first adding unit (not shown) or a second adding unit (not shown).

The first adding unit is configured to add the friend identifiers corresponding to the N friends into the friend address bar in response to a detection of an event of the friend-select icons corresponding to the N friends in the friend list being checked by the user account.

The second adding unit is configured to add the N friend identifiers or the friend identifiers corresponding to N friend images into the friend address bar in response to a detection of an event of the friend identifiers or the friend images corresponding to the N friends in the friend list being clicked by the user account.

In addition, the device for selecting friends in microblogging in this embodiment may further include a hiding module (not shown), which is configured to perform a left-hiding operation on the text in the friend address bar when the text has a size larger than a predetermined value.

In summary, when trying to select N friends for an information sharing in microblogging, a user account only needs to click the friend-select trigger button one time and thereby being able to select the N friends from the friend list displayed on the friend-select interface called by the friend-select trigger button. Consequentially, the selection of the N friends in microblogging is realized when a related mobile device detects an even of the friend-confirm button being clicked by the user account. Thus, compared with the prior art requiring to click the friend-select trigger button N times for the selection of the N friends, the present embodiment provides an improved user experience when users try to perform a multi friend selection in microblogging.

It is to be noted that the embodiments in the present invention are described in progressive manner. In other words, only the specifications or characteristics different with those in other embodiment are described in the respective embodiment; the same or similar parts among the embodiments can be obtained by cross-reference. In addition, it is understood that the device embodiment of the present invention has a simpler description due to that most of the specifications or characteristics therein have been described in the method embodiments of the present invention.

It is to be noted that the use of “including,” “comprising,” or “having” and variations thereof herein is meant to encompass the items listed thereafter and equivalents thereof as well as additional items. In other words, the embodiments disclosed in the present invention each may further include one or more steps or elements not listed.

In addition, the ordinary skill in the art can understand that all or part of the steps in the aforementioned method embodiments can be realized by related hardware instructed by programs, the corresponding programs can be stored in a readable storage medium of computer, such as a ROM, RAM, disk or optical disk, etc.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

### INDUSTRIAL APPLICABILITY

When trying to select N friends for an information sharing in microblogging, a user account only needs to click the friend-select trigger button one time and thereby being able to select the N friends from the friend list displayed on the friend-select interface called by the friend-select trigger button. Consequentially, the selection of the N friends in microblogging is realized when a related mobile device detects an even of the friend-confirm button being clicked by the user account. Thus, compared with the prior art requiring to click the friend-select trigger button N times for the selection of the N friends, the present invention provides an improved user experience when users try to perform a multi friend selection in microblogging.

What is claimed is:

1. A method for selecting friends in a microblogging, the method comprising steps of:
calling a friend-select interface and displaying a friend list, a friend address bar and a friend-confirm button on the friend-select interface in response to a detection of an event of a friend-select trigger button being clicked by a user account;
adding friend identifiers corresponding to N friends into the friend address bar in response to a detection of an event of the N friends in the friend list being selected by the user account; and
detecting an even of the friend-confirm button being clicked by the user account and thereby realizing a selection of the N friends in the microblogging;
wherein N is an integer and greater than 1.

2. The method according to claim 1, wherein the step of adding friend identifiers corresponding to N friends into the friend address bar in response to a detection of an event of the N friends in the friend list being selected by the user account comprises:
adding the friend identifiers corresponding to the N friends into the friend address bar in response to a detection of an event of friend-select icons corresponding to the N friends in the friend list being checked by the user account.

3. The method according to claim 1, wherein the step of adding friend identifiers corresponding to N friends into the friend address bar in response to a detection of an event of the N friends in the friend list being selected by the user account comprises:
adding the N friend identifiers or the friend identifiers corresponding to N friend images into the friend address bar in response to a detection of an event of the friend identifiers or the friend images corresponding to the N friends in the friend list being clicked by the user account.

4. The method according to claim 1, further comprising:
performing a left-hiding operation on a text in the friend address bar when the text therein has a size greater than a predetermined value.

5. The method according to claim 1, wherein the friend identifier comprises a nickname of the respective friend.

6. A device for selecting friends in a microblogging, the device comprising:
a call-and-display module configured to call a friend-select interface and display a friend list, a friend address bar and a friend-confirm button on the friend-select interface in response to a detection of an event of a friend-select trigger button being clicked by a user account;
an adding module configured to add friend identifiers corresponding to N friends into the friend address bar in response to a detection of an event of the N friends in the friend list being selected by the user account; and
a detecting module configured to detect an even of the friend-confirm button being clicked by the user account and thereby realizing a selection of the N friends in the microblogging;
wherein N is an integer and greater than 1.

7. The device according to claim 6, wherein the adding module comprises:
a first adding unit configured to add the friend identifiers corresponding to the N friends into the friend address bar in response to a detection of an event of friend-select icons corresponding to the N friends in the friend list being checked by the user account.

8. The device according to claim 7, wherein the adding module further comprises:
a second adding unit configured to add the N friend identifiers or the friend identifiers corresponding to N friend images into the friend address bar in response to a detection of an event of the friend identifiers or the friend images corresponding to the N friends in the friend list being clicked by the user account.

9. The device according to claim 6, further comprising:
a hiding module configured to perform a left-hiding operation on a text in the friend address bar when the text therein has a size greater than a predetermined value.
